(19) United States
(12) Patent Application Publication
(10) Pub. No.: US 2025/0252881 A1
(43) Pub. Date: Aug. 7, 2025

(54) DISPLAY DEVICE AND ELECTRONIC DEVICE HAVING THE SAME

(71) Applicant: SAMSUNG DISPLAY CO., LTD., YONGIN-SI (KR)

(72) Inventor: Ki Myeong EOM, Yongin-si (KR)

(21) Appl. No.: 18/804,579

(22) Filed: Aug. 14, 2024

(30) Foreign Application Priority Data
Feb. 6, 2024 (KR) 10-2024-0018437

(51) Int. Cl. G09G 3/20

(52) U.S. Cl. CPC G09G 3/20; G09G 2300/0819; G09G 2300/0842; G09G 2300/0861; G09G 2310/0286; G09G 2320/0257; G09G 2330/021

(57) ABSTRACT

A display device includes a display panel including sub-pixels, a data driver, a gate driver, and a power voltage generator. The data driver provides data voltages to the sub-pixels. The gate driver receives a first input voltage as a first gate low voltage and provides gate signals to the sub-pixels. The power voltage generator receives the first input voltage and a second input voltage, generates a second gate low voltage based on the first input voltage and the second input voltage, and provides the second gate low voltage to the gate driver. The display device may also include a driving controller for controlling the data driver, the gate driver, and the power voltage generator.

### CROSS-REFERENCE TO RELATED APPLICATION

The present application claims priority under 35 U.S.C. § 119 (a) to Korean patent application No. 10-2024-0018437, filed on Feb. 6, 2024, in the Korean Intellectual Property Office, the entire disclosure of which is incorporated by reference herein.

### BACKGROUND

### 1. Technical Field

The present disclosure generally relates to a display device and an electronic device having a display device.

### 2. Related Art

A variety of display devices have been developed. Examples include liquid crystal display devices and organic light emitting display devices. Various studies has been performed for reducing power consumption of display devices.

### SUMMARY

In accordance with an aspect of the present disclosure, there is provided a display device including: a display panel including sub-pixels; a gate driver; a driver integrated circuit that includes a data driver configured to provide data voltages to the sub-pixels, and a power voltage generator configured to receive a first input voltage and a second input voltage, generate a second gate low voltage based on the first input voltage and the second input voltage, and provide the second gate low voltage to the gate driver, wherein the gate driver is configured to receive the first input voltage as a first gate low voltage, and provide gate signals to the sub-pixels.

The second gate low voltage may have a value obtained by subtracting the second input voltage from the first input voltage.

The power voltage generator may include a charge pump circuit configured to generate the second gate low voltage based on the first input voltage and the second input voltage.

The charge pump circuit may include: a first switch including a first terminal connected to a first reference potential and a second terminal connected to a first node; a second switch including a first terminal connected to the first node and a second terminal connected to a second node; a third switch including a first terminal receiving the second input voltage and a second terminal connected to the second node; a fourth switch including a first terminal connected to a second reference potential and a second terminal connected to a third node; a fifth switch including a first terminal receiving the first input voltage and a second terminal connected to the third node; a sixth switch including a first terminal connected to third reference potential and a second terminal connected to a fourth node; a seventh switch including a first terminal connected to the fourth node and a second terminal connected to a fifth node; a first capacitor including a first electrode connected to the first node and a second electrode connected to the third node; a second capacitor including a first electrode connected to the second node and a second electrode connected to the fourth node; and a third capacitor including a first electrode connected to the fifth node and a second electrode connected to a fourth reference potential. The second gate low voltage may be generated using a voltage stored in the third capacitor.

A voltage generation period in which the second gate low voltage is generated may include a first period, a second period subsequent to the first period, and a third period subsequent to the second period. The first switch, the third switch, the fifth switch, and the sixth switch may be turned on in the first period, the fourth switch may be turned on in the second period, and the second switch and the seventh switch may be turned on in the third period.

The gate driver may output the first gate low voltage as a low logic level of the gate signals.

The gate driver may include a stage configured to output at least one of the gate signals. The stage may include: an input stage transistor including a control electrode receiving a first clock signal, a first electrode receiving an input signal, and a second electrode connected to a first stage node; a control unit (or controller) configured to control a signal of a second stage node and a signal of a third stage node, based on a signal of the first stage node; a first output stage transistor including a control electrode connected to the second stage node, a first electrode receiving a gate high voltage, and a second electrode connected to an output terminal; and a second output stage transistor including a control electrode connected to the third stage node, a first electrode receiving the first gate low voltage, and a second electrode connected to the output terminal. The stage may output the gate high voltage or the first gate low voltage.

The second input voltage may be applied to at least one of a back gate electrode of a transistor included in the control unit or a back gate electrode of the input stage transistor.

An absolute value of the second gate low voltage may be greater than an absolute value of the first gate low voltage.

Each of the first gate low voltage and the second gate low voltage may have a negative value.

The second input voltage may be greater than the first input voltage.

The first input voltage may have a negative value, and the second input voltage may have a positive value.

The second input voltage may be greater than the second gate low voltage.

The display device may further include an emission driver configured to receive the first input voltage as the first gate low voltage, receive the second gate low voltage from the power voltage generator, and provide emission signals to the sub-pixels.

The emission driver may output the first gate low voltage as a low logic level of the emission signals.

The emission driver may include a stage configured to output at least one of the emission signals. The stage may include: an input stage transistor including a control electrode receiving a first clock signal, a first electrode receiving an input signal, and a second electrode connected to a first stage node; a control unit (or controller) configured to control a signal of a second stage node and a signal of a third stage node, based on a signal of the first stage node; a first output stage transistor including a control electrode connected to the second stage node, a first electrode receiving a gate high voltage, and a second electrode connected to an output terminal; and a second output stage transistor including a control electrode connected to the third stage node, a first electrode receiving the first gate low voltage, and a second electrode connected to the output terminal. The stage may output the gate high voltage or the first gate low voltage.

The second input voltage may be applied to at least one of a back gate electrode of a transistor included in the control unit or a back gate electrode of the input stage transistor.

At least one of the sub-pixels may receive an initialization voltage. The power voltage generator may generate the initialization voltage based on the first input voltage.

The power voltage generator may further include a regulator configured to receive the first input voltage to generate the initialization voltage.

In accordance with another aspect of the present disclosure, there is provided an electronic device including: a processor configured to provide input image data to a display device; the display device configured to receive the input image data to display an image; and a voltage supply configured to provide a first input voltage and a second input voltage to the display device, wherein the display device includes: a display panel including sub-pixels; a gate driver; a driver integrated circuit includes a data driver configured to provide data voltages to the sub-pixels, and a power voltage generator configured to receive the first input voltage and the second input voltage, generate a second gate low voltage based on the first input voltage and the second input voltage, and provide the second gate low voltage to the gate driver, wherein the gate driver is configured to receive the first input voltage as a first gate low voltage, and provide gate signals to the sub-pixels.

In accordance with one or more embodiments, a power voltage generator includes a regulator configured to generate a first voltage based on a first signal; and a voltage generator configured a second voltage based on a first input voltage and a second input voltage, wherein: each of the regulator and the voltage generator is electrically connected to a driver of a display device, the first voltage corresponds to a logical high voltage for the driver and the first input voltage corresponds to a logical low voltage for the driver, and the second voltage is a back gate bias voltage for at least one transistor in the driver. The first signal is a third input voltage. The second input voltage is greater than the first input voltage. The second input voltage is greater than the second voltage. The second voltage is equal to the first input voltage minus the second input voltage.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

FIG. 1 is a block diagram illustrating a display device in accordance with embodiments of the present disclosure.

FIG. 2 is a circuit diagram illustrating an example of a sub-pixel of the display device shown in FIG. 1.

FIGS. 3 and 4 are diagrams illustrating an example of wavelengths of gate signals and an emission signal, which are input to the sub-pixel shown in FIG. 2.

FIG. 5 is a diagram illustrating an example of a gate driver and an emission driver of the display device shown in FIG. 1 according to an embodiment.

FIG. 6 is a circuit diagram illustrating an example of a first stage of the emission driver shown in FIG. 5.

FIG. 7 is a block diagram illustrating an example of a power voltage generator of the display device shown in FIG. 1.

FIG. 8 is a circuit diagram illustrating an example of a second gate low voltage generator shown in FIG. 7.

FIG. 9 is a circuit diagram illustrating an example in which the second gate low voltage generator shown in FIG. 8 is driven in a first period of a voltage generation period.

FIG. 10 is a circuit diagram illustrating an example in which the second gate low voltage generator shown in FIG. 8 is driven in a second period of the voltage generation period.

FIG. 11 is a circuit diagram illustrating an example in which the second gate low voltage generator shown in FIG. 8 is driven in a third period of the voltage generation period.

FIG. 12 is a block diagram illustrating an electronic device in accordance with embodiments of the present disclosure.

FIG. 13 is a diagram illustrating an example in which the electronic device shown in FIG. 12 is implemented as a smartphone.

### DETAILED DESCRIPTION

Hereinafter, exemplary embodiments of the present disclosure will be described in more detail with reference to the accompanying drawings. The present disclosure is not limited to exemplary embodiments described herein, but may be embodied in various different forms. Rather, exemplary embodiments described herein are provided to thoroughly and completely describe the disclosed contents and to sufficiently transfer the ideas of the disclosure to a person of ordinary skill in the art.

In the entire specification, when an element is referred to as being “connected” or “coupled” to another element, it can be directly connected or coupled to the another element or be indirectly connected or coupled to the another element with one or more intervening elements interposed therebetween. The technical terms used herein are used only for the purpose of illustrating a specific embodiment and not intended to limit the embodiment. It will be understood that when a component “includes” an element, unless there is another opposite description thereto, it should be understood that the component does not exclude another element but may further include another element. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Similarly, for the purposes of this disclosure, “at least one selected from the group consisting of X, Y, and Z” can be construed as X only, Y only, Z only, or any combination of two or more items X, Y, and Z (e.g., XYZ, XYY, YZ, ZZ).

It will be understood that, although the terms “first”, “second,” etc. may be used herein to describe various elements, these elements should not be limited by these terms. These terms are only used to distinguish one element from another element. Thus, a “first” element discussed below could also be termed a “second” element without departing from the teachings of the present disclosure.

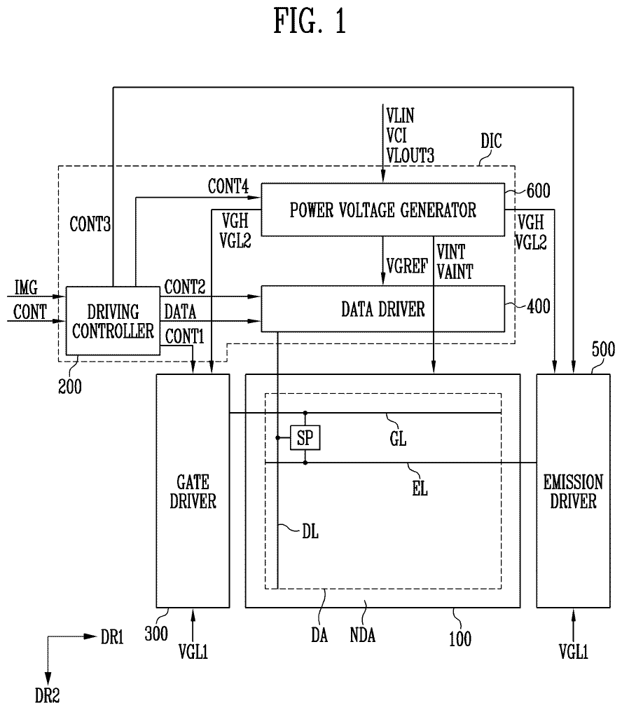

FIG. 1 is a block diagram illustrating a display device in accordance with embodiments of the present disclosure.

Referring to FIG. 1, the display device may include a display panel 100, a driving controller 200, a gate driver 300, a data driver 400, an emission driver 500, and a power voltage generator 600.

Two or more components among the driving controller 200, the data driver 400, and the power voltage generator 600 may be mounted in one integrated circuit. As shown in FIG. 1, the driving controller 200, the data driver 400, and the power voltage generator 600 may be included in a driver integrated circuit DIC. The driving controller 200, the data driver 400, and the power voltage generator 600 may be components functionally divided in one driver integrated circuit DIC. In other embodiments, at least one of the driving controller 200, the data driver 400, or the power voltage generator 600 may be provided as a component distinguished from the driver integrated circuit DIC.

The display panel 100 may include a display area DA in which an image is displayed and a non-display area NDA disposed adjacent to the display area DA. In some embodiment, the non-display area NDA may entirely surround the display area DA. In other embodiments, the non-display area NDA may only partially surround the display area DA. In an embodiment, the gate driver 300 and the emission driver 500 may be mounted in the non-display area NDA. The gate driver 300 and the emission driver 500 may be located on respective sides of the display area DA, or may be located on a same side of the display area DA. The display panel 100 may include a plurality of gate lines GL, a plurality of data lines, a plurality of emission lines EL, and a plurality of sub-pixels SP electrically connected to the gate lines GL, the data lines DL, and the emission lines EL. The gate lines GL and the emission lines EL may extend in a first direction DR1, and the data lines DL may extend in a second direction DR2 intersecting (or disposed perpendicular to) the first direction DR1. In one embodiment, each pixel of the display panel 100 may include a plurality of sub-pixels, each emitting a different color of light, e.g., red light, blue light, and green light respectively. The sub-pixels SP of each pixel may emit light of a different combination of colors in another embodiment.

The driving controller 200 may receive input image data IMG and an input control signal CONT from a host. The host may be an electronic device which includes the display device, or the host may be communicate with the driving controller 200 through at least one communication line. In one embodiment, the host may include a main processor (e.g., a graphic processing unit (GPU) or the like). For example, the input image data IMG may include color image data, e.g., red image data, green image data, and blue image data. In an embodiment, the input image data IMG may further include white image data. In another example, the input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a plurality of signals. For example, the driving controller 200 may generate a first control signal CONT1, a second control signal CONT2, a third control signal CONT3, a fourth control signal CONT4, and a data signal DATA, based on the input image data IMG and the input control signal CONT.

The driving controller 200 may generate the first control signal CONT1 for controlling operation of the gate driver 300 based on the input control signal CONT, and output the first control signal CONT1 to the gate driver 300. The first control signal CONT1 may include, for example, a vertical start signal and a gate clock signal.

The driving controller 200 may generate the second control signal CONT2 for controlling operation of the data driver 400 based on the input control signal CONT, and output the second control signal CONT2 to the data driver 400. The second control signal CONT2 may include, for example, a horizontal start signal and a load signal.

The driving controller 200 may generate the data signal DATA based on the input image data IMG and the input control signal CONT. The driving controller 200 may output the data signal DATA to the data driver 400.

The driving controller 200 may generate the third control signal CONT3 for controlling operation of the emission driver 500 based on the input control signal CONT, and output the third control signal CONT3 to the emission driver 500. The third control signal CONT3 may include, for example, a vertical start signal and an emission clock signal.

The driving controller 200 may generate the fourth control signal CONT4 for controlling operation of the power voltage generator 600 based on the input control signal CONT, and output the fourth control signal CONT4 to the power voltage generator 600.

The gate driver 300 may generate gate signals for driving the gate lines GL in response to the first control signal CONT1 input from the driving controller 200. The gate driver 300 may output the gate signals to the gate lines GL. For example, the gate driver 300 may sequentially output the gate signals to the gate lines GL.

The data driver 400 may receive the second control signal CONT2 and the data signal DATA, which are input from the driving controller 200. The data driver 400 may receive a gamma reference voltage VGREF input from the power voltage generator 600. The data driver 400 may generate data voltages obtained by converting the data signal DATA into a voltage in an analog form. The gamma reference voltage VGREF is used to perform gamma correction of data signals of the data driver 400. For example, the data driver 400 may generate a data voltage of each grayscale value, using the gamma reference voltage VGREF including a data voltage of each grayscale value. The data driver 400 may output the data voltages to corresponding ones of the data lines DL.

The emission driver 500 may generate emission signals for driving the emission lines EL in response to the third control signal CONT3 input from the driving controller 200. The emission driver 500 may output the emission signals to the emission lines EL. For example, the emission driver 500 may sequentially output the emission signals to the emission lines EL.

The power voltage generator 600 may generate power voltages VGH, VGL2, VINT, VAINT, and VGREF in response to the fourth control signal CONT4 input from the driving controller 200. The power voltage generator 600 may receive a first input voltage VLOUT3, a second input voltage VCI, and a third input voltage VLIN. These input voltages may be received, for example, from a host. The power voltage generator 600 may generate initialization voltages VINT and VAINT based on the first input voltage VLOUT3. The power voltage generator 600 may generate a second gate low voltage VGL2 based on the first input voltage VLOUT3 and the second input voltage VCI. The power voltage generator 600 may generate a gate high voltage VGH and the gamma reference voltage VGREF based on the third input voltage VLIN.

The power voltage generator 600 may provide the gate high voltage VGH and the second gate low voltage VGL2 to the gate driver 300 and the emission driver 500. The power voltage generator 600 may provide the initialization voltages VINT and VAINT to the display panel 100.

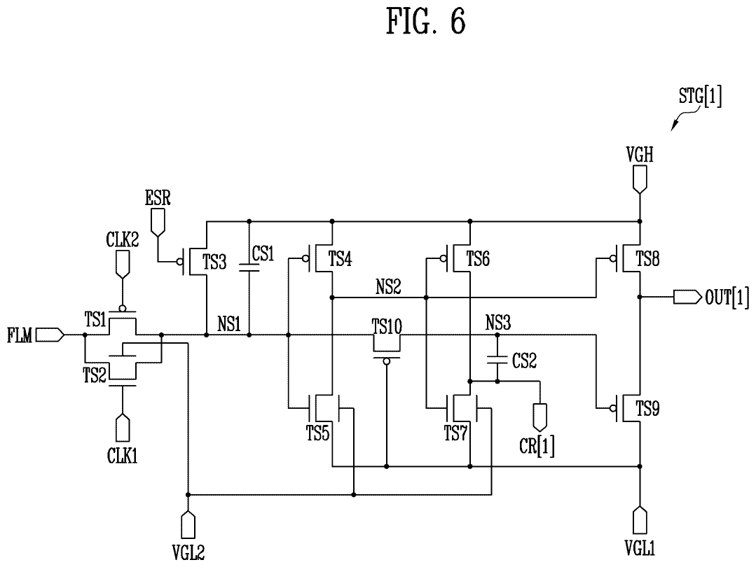

The gate driver 300 and the emission driver 500 may receive the first input voltage VLOUT3 as the first gate low voltage VGL1, as explained, for example, with reference to FIG. 6. The gate driver 300 and the emission driver 500 may use the gate high voltage VGH as a high logic level, and use the first gate low voltage VGL1 as a low logic level. This will be described in detail later.

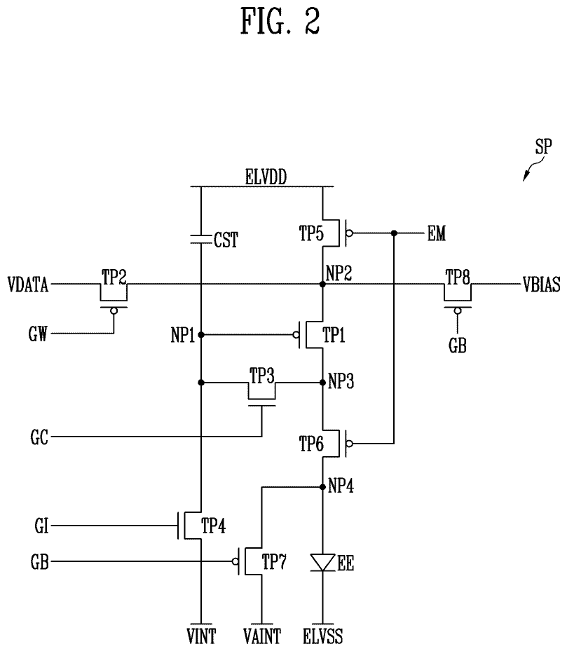

FIG. 2 is a circuit diagram illustrating an example of a sub-pixel SP which may be representative of the each of the sub-pixels of the display device shown in FIG. 1.

Referring to FIG. 2, each of the sub-pixels SP may include a first pixel transistor TP1 (e.g., a driving transistor), a second pixel transistor TP2, a third pixel transistor TP3, a fourth pixel transistor TP4, a fifth pixel transistor TP5, a sixth pixel transistor TP6, a seventh pixel transistor TP7, and an eighth pixel transistor TP8.

The first pixel transistor TP1 includes a control electrode connected to a first pixel node NP1, a first electrode connected to a second pixel node NP2, and a second electrode connected to a third pixel node NP3. The second pixel transistor TP2 includes a control electrode receiving a write gate signal GW, a first electrode receiving a data voltage VDATA, and a second electrode connected to the second pixel node NP2. The third pixel transistor TP3 includes a control electrode receiving a compensation gate signal GC, a first electrode connected to the third pixel node NP3, and a second electrode connected to the first pixel node NP1. The fourth pixel transistor TP4 includes a control electrode receiving an initialization gate signal GI, a first electrode receiving the first initialization voltage VINT, and a second electrode connected to the first pixel node NP1. The fifth pixel transistor TP5 includes a control electrode receiving an emission signal EM, a first electrode receiving a first power voltage ELVDD (e.g., a high power voltage), and a second electrode connected to the second pixel node NP2. The sixth pixel transistor TP6 includes a control electrode receiving the emission signal EM, a first electrode connected to the third pixel node NP3, and a second electrode connected to a fourth pixel node NP4. The seventh pixel transistor TP7 includes a control electrode receiving a bias gate signal GB, a first electrode receiving the second initialization voltage VAINT, and a second electrode connected to the fourth pixel node NP4. The eighth pixel transistor TP8 includes a control electrode receiving the bias gate signal GB, a first electrode receiving a bias voltage VBIAS, and a second electrode connected to the second pixel node NP2.

The sub-pixel may also include a storage capacitor CST and a light emitting element EE. The storage capacitor CST includes a first electrode receiving the first power voltage ELVDD and a second electrode connected to the first pixel node NP1. The light emitting element EE includes a first electrode (e.g., an anode electrode) connected to the fourth pixel node NP4 and a second electrode (e.g., a cathode electrode) receiving a second power voltage ELVSS (e.g., a low power voltage). However, the present disclosure is not limited thereto. For example, each of the sub-pixels SP may have a 3T1C structure configured with three transistors and one capacitor, a 5T2C structure configured with five transistors and two capacitors, a 7T1C structure configured with seven transistors and one capacitor, a 9T1C structure configured with nine transistors and one capacitor, or the like.

The first, second, and fifth to eighth pixel transistors TP1, TP2, TP5, TP6, TP7, and TP8 may be implemented with a p-channel metal oxide semiconductor (PMOS) transistor. A low logic level may be an activation (or on state) level, and a high logic level may be an inactivation (or off state) level. For example, when a signal applied to a control electrode of the PMOS transistor has the low logic level, the PMOS transistor may be turned on. For example, when the signal applied to the control electrode of the PMOS transistor is the high logic level, the PMOS transistor may be turned off.

The third and fourth pixel transistors TP3 and TP4 may be implemented with an n-channel metal oxide semiconductor (NMOS) transistor. A low logic level may be an inactivation (or off state) level, and a high logic level may be an activation (or on state) level. For example, when a signal applied to a control electrode of the NMOS transistor has the low logic level, the NMOS transistor may be turned off. For example, when the signal applied to the control electrode of the NMOS transistor has the high logic level, the NMOS transistor may be turned on. Thus, the activation level and the inactivation level may be determined according to the kind of transistor.

However, the present disclosure is not limited to the aforementioned conductivities. For example, the first, second, and fifth to eighth pixel transistors TP1, TP2, TP5, TP6, TP7, and TP8 may be implemented with an NMOS transistor. For example, the third and fourth pixel transistors TP3 and TP4 may be implemented with a PMOS transistor.

For example, in an initialization period, the initialization gate signal GI may have the activation level, and the fourth pixel transistor TP4 may be turned on. Accordingly, the first initialization voltage VINT may be applied to the first pixel node NP1 (e.g., performs a gate initialization operation). Thus, the control electrode of the first pixel transistor TP1 (and the node NP1 coupled to the storage capacitor CST) may be initialized.

For example, in a data writing period, the write gate signal GW and the compensation gate signal GC may have the activation level, and thus the second pixel transistor TP2 and the third pixel transistor TP3 may be turned on. Accordingly, the data voltage VDATA may be written to the storage capacitor CST.

For example, in an anode initialization period, the bias gate signal GB may have the activation level, and thus the seventh pixel transistor TP7 and the eighth pixel transistor TP8 may be turned on. Accordingly, the second initialization voltage VAINT (e.g., an anode initialization voltage) may be applied to the first electrode (e.g., the anode electrode) of the light emitting element EE, and the bias voltage VBIAS may be applied to the first electrode of the first pixel transistor TP1.

For example, in an emission period, the emission signal EM may have the activation level, and thus the fifth pixel transistor TP5 and the sixth pixel transistor TP6 may be turned on. Accordingly, as the first power voltage ELVDD is applied to the first pixel transistor TP1, a driving current may be generated proportional to the data voltage stored in the storage capacitor CST. The driving current may be applied to the light emitting element EE. As a result, the light emitting element EE may emit light with a luminance (or grayscale value) corresponding to the driving current.

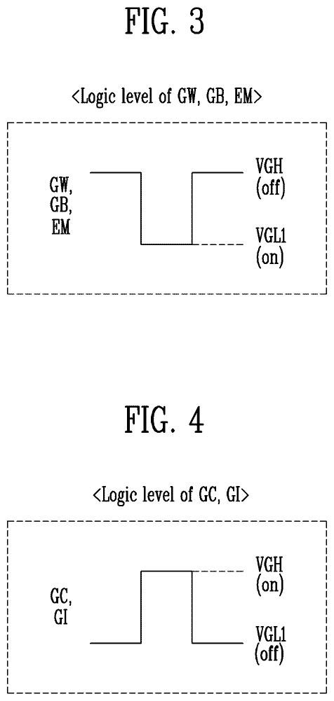

FIGS. 3 and 4 are diagrams illustrating an example of waveforms of the gate signals and the emission signal, which are input to the sub-pixel shown in FIG. 2.

Referring to FIGS. 3 and 4, the gate signals GW, GC, GI, and GB and the emission signal EM may have a high logic level or a low logic level. The gate high voltage VGH may have the high logic level, and the first gate low voltage VGL1 may have the low logic level.

Referring to FIG. 3, for a PMOS transistor, the low logic level may be an activation level and the high logic level may be an inactivation level. For example, the activation level of the write gate signal GW, the bias gate signal GB, and the emission signal EM may be the low logic level (e.g., may correspond to the first gate low voltage VGL1), and the inactivation level of the write gate signal GW, the bias gate signal GB, and the emission signal EM may be the high logic level (e.g., may correspond to the gate high voltage VGH).

Referring to FIG. 4, for an NMOS transistor, the high logic level may be the activation level and the low logic level may be the inactivation level. For example, the activation level of the compensation gate signal GC and the initialization gate signal GI may be the high logic level (e.g., may correspond to the gate high voltage VGH). The inactivation level of the compensation gate signal GC and the initialization gate signal GI may be the logic low level (e.g., may correspond to the first gate low voltage VGL1).

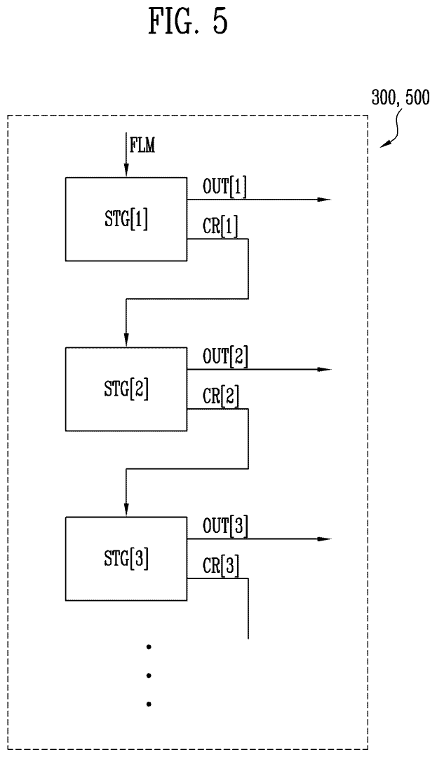

FIG. 5 is a diagram illustrating an example of the gate driver 300 and the emission driver 500 of the display device shown in FIG. 1.

Referring to FIGS. 1 and 5, the gate driver 300 may include a plurality of stages STG[1], STG[2], STG[3], . . . . For generating outputs sequentially. The stages STG[1], STG[2], STG[3], . . . may output output signals OUT[1], OUT[2], OUT[3], . . . to respective ones of the gate lines GL connected thereto, sequentially. The output signals OUT[1], OUT[2], OUT[3], . . . of the gate driver 300 may be gate signals.

For example, a first stage STG[1] of the gate driver 300 may output a first output signal OUT[1] to a gate line GL of a first pixel row. For example, a second stage STG[2] of the gate driver 300 may output a second output signal OUT[2] to a gate line GL of a second pixel row. For example, a third stage STG[3] of the gate driver 300 may output a third output signal OUT[3] to a gate line GL of a third pixel row, and so on.

The emission driver 500 may include a plurality of stages STG[1], STG[2], STG[3], . . . for sequentially generating output voltages. The stages STG[1], STG[2], STG[3], . . . may output output signals OUT[1], OUT[2], OUT[3], . . . to respective ones of the emission lines EL connected thereto, sequentially. The output signals OUT[1], OUT[2], OUT[3], . . . of the emission driver 500 may be emission signals.

For example, a first stage STG[1] of the emission driver 500 may output a first output signal OUT[1] to an emission line EL of the first pixel row. For example, a second stage STG[2] of the emission driver 500 may output a second output signal OUT[2] to an emission line EL of the second pixel row. For example, a third stage STG[3] of the emission driver 500 may output a third output signal OUT[3] to an emission line EL of the third pixel row.

In an embodiment, the stages STG[2], STG[3], STG[4] . . . except the first stage STG[1] may receive carry signals CR[1], CR[2], CR[3] generated by previous stages to generate the output signals OUT[2], OUT[3], OUT[4] . . . , respectively. In an embodiment, the first stage STG[1] may receive a start signal FLM, instead of one of the carry signals CR[1], CR[2], CR[3], to generate the first output signal OUT[1].

However, the present disclosure is not limited to the structure of the gate driver 300 and the emission driver 500 shown in FIG. 5, and may have different structures in other embodiments.

FIG. 6 is a circuit diagram illustrating an example of the first stage STG[1] of the emission driver shown in FIG. 5. The stages STG[2] (e.g., STG[2], STG[3], . . . ) except the first stage STG[1] may be substantially identical to the first stage STG[1] except that the stages receive the carry signals CR[1], CR[2], CR[3], . . . instead of the start signal FLM. In an embodiment, a first clock signal CLK1 and a second clock signal CLK2 may be reversed to each other according to each of the stages STG[1], STG[2], STG[3], . . . .

Referring to FIGS. 5 and 6, the emission driver 500 may output the first gate low voltage VGL1 as a low logic level of emission signals. The emission driver 500 may output the gate high voltage VGH as a high logic level of the emission signals.

The second input voltage VGL2 may be applied to back gate electrodes of transistors (e.g., second, fifth, and seventh stage transistors TS2, TS5, and TS7) included in the emission driver 500. For example, the second input voltage VGL2 may be used to initialize a back gate bias of a transistor included in the emission driver 500.

In an embodiment, each of the stages STG[1], STG[2], STG[3], . . . may include an input stage transistor, a control unit (or controller), a first output stage transistor, and a second output stage transistor. The input stage transistor (e.g., the second stage transistor TS2) includes a control electrode receiving the first clock signal CLK1, a first electrode receiving an input signal (e.g., the start signal FLM or the carry signal CR[1], CR[2], CR[3], . . . ), and a second electrode connected to a first stage node NS1. The control unit controls a signal of a second stage node NS2 and a signal of a third stage node NS3, based on a signal of the first stage node NS1. The first output stage transistor (e.g., an eighth stage transistor TS8) includes a control electrode connected to the second stage node NS2, a first electrode receiving the gate high voltage VGH, and a second electrode connected to an output terminal. The second output stage transistor (e.g., a ninth stage transistor TS9) includes a control electrode connected to the third stage node NS3, a first electrode receiving the first gate low voltage VGL1, and a second electrode connected to the output terminal. In one embodiment, the control unit may include third to seventh transistors TS3 to TS7 and first and second stage capacitors CS1 and CS2.

For example, the first stage STG[1] may include a first stage transistor TS1 including a control electrode receiving the second clock signal CLK2, a first electrode receiving the start signal FLM, and a second electrode connected to the first stage node NS1. The first stage STG[1] may also include the second stage transistor TS2 through the ninth stage transistor TS9. The second stage transistor TS2 includes a control electrode receiving the first clock signal CLK1, a first electrode receiving the start signal FLM, a second electrode connected to the first stage node NS1, and a back gate electrode receiving the second gate low voltage VGL2. The third stage transistor TS3 includes a control electrode receiving an off-control signal ESR, a first electrode receiving the gate high voltage VGH, and a second electrode connected to the first stage node NS1. The fourth stage transistor TS4 includes a control electrode connected to the first stage node NS1, a first electrode receiving the gate high voltage VGH, and a second electrode connected to the second stage node NS2. The fifth stage transistor TS5 includes a control electrode connected to the first stage node NS1, a first electrode connected to the first gate low voltage VGL1, a second electrode connected to the second stage node NS2, and a back gate electrode receiving the second gate low voltage VGL2. The sixth stage transistor TS6 includes a gate electrode receiving the second stage node NS2, a first electrode receiving the gate high voltage VGH, and a second electrode connected to a first output terminal through which a first carry signal CR[1] is output. The seventh stage transistor TS7 includes a control electrode connected to the second stage node NS2, a first electrode receiving the first gate low voltage VGL1, a second electrode connected to the first output terminal, and a back gate electrode receiving the second gate low voltage VGL2. The eighth stage transistor TS8 includes a control electrode connected to the second stage node NS2, a first electrode receiving the gate high voltage VGH, and a second electrode connected to a second output terminal through which the first output signal OUT[1] is output. The ninth stage transistor TS9 includes a control electrode connected to the third stage node NS3, a first electrode connected to the first gate low voltage VGL1, and a second electrode connected to the second output terminal

The first stage STG[1] may also include the first stage capacitor CS1 and the second stage capacitor CS2. The first stage capacitor CS1 includes a first electrode receive the gate high voltage VGH and a second electrode connected to the first stage node NS1. The second stage capacitor CS2 includes a first electrode connected to the third stage node NS3 and a second electrode connected to the first output terminal.

The gate driver 300 may output the first gate low voltage VGL1 as a low logic level of gate signals. The gate driver 300 may output the gate high voltage VGH as a high logic level of the gate signals.

The second input voltage VGL2 may be applied to a back gate electrode of the transistors included in the gate driver 300. For example, the second input voltage VGL2 may be used to initialize a back gate bias of a transistor included in the gate driver 300.

The stages STG[1], STG[2], STG[3], . . . of the gate driver 300 may be configured substantially identically to the stages STG[1], STG[2], STG[3], . . . of the emission driver 500, except that the output signals OUT[1], OUT[2], OUT[3], . . . are gate signals. However, the present disclosure is not limited thereto. For example, at least a portion of the stages STG[1], STG[2], STG[3], . . . of the gate driver 300 may be configured differently from the stages STG[1], STG[2], STG[3], . . . of the emission driver 500, except that the first gate low voltage VGL1 is output as the low logic level and that the second gate low voltage VGL2 initializes the back gate bias of corresponding ones of the transistors.

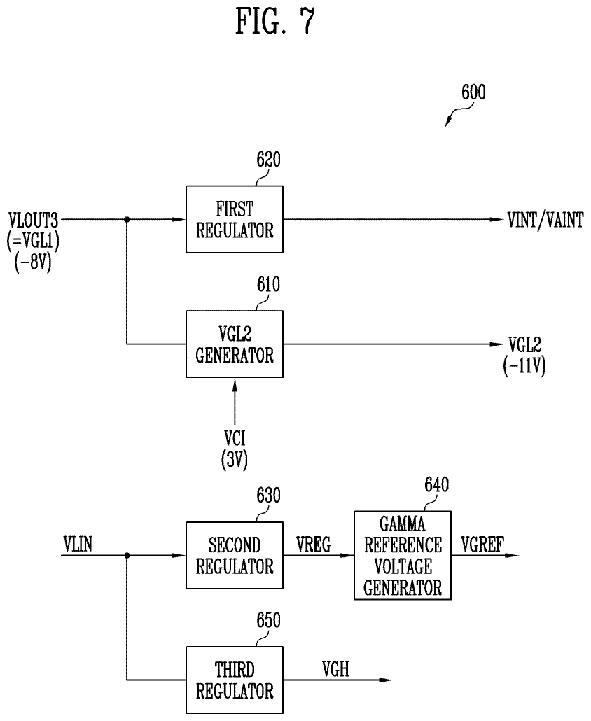

FIG. 7 is a block diagram illustrating an example of the power voltage generator 600 of the display device shown in FIG. 1.

Referring to FIG. 7, the power voltage generator 600 may include a second gate low voltage (VGL2) generator 610, a first regulator 620, a second regulator 630, and a third regulator 650.

The second gate low voltage generator 610 may generate a second gate low voltage VGL2 based on a first input voltage VLOUT3 and a second input voltage VCI.

An absolute value of the second gate low voltage VGL2 may be greater than an absolute value of a first gate low voltage VGL1 (e.g., the first input voltage VLOUT3). In one embodiment, each of the first gate low voltage VGL1 (e.g., the first input voltage VLOUT3) and the second gate low voltage VGL2 may have a negative value.

In one embodiment, the second input voltage VCI may be greater than the first input voltage VLOUT3. For example, the first input voltage VLOUT3 may have a negative value and the second input voltage VCI may have a positive value. The second input voltage VCI may be greater than the second gate low voltage VGL2. For example, the first input voltage VLOUT3 may be −8V, the second input voltage VCI may be 3V, and the second gate low voltage VGL2 may be −11V. However, the first input voltage VLOUT3, the second input voltage VCI, and/or the second gate low voltage VGL2 may be different values in other embodiments.

In an embodiment, the second gate low voltage VGL2 may have a value obtained by subtracting the second input voltage VCI from the first input voltage VLOUT3. For example, when the first input voltage VLOUT3 is −8V and the second input voltage VCI is 3V, the second gate low voltage VGL2 may be −11V.

As shown in FIG. 6, since the second gate low voltage VGL2 may be a voltage for initializing a back gate bias and the first gate low voltage VGL1 is a voltage used as a low logic level, a current generated by the first gate low voltage VGL1 may be greater than a current generated by the second gate low voltage VGL2. Therefore, in the display device, the second gate low voltage VGL2 (by which a relatively small current is generated) may be generated through the power voltage generator 600, and the first gate low voltage VGL1 (by which a relatively large current is generated) may be supplied as an input voltage to the gate driver 300. Accordingly, power consumption of the power voltage generator 600 can be reduced.

The first regulator 620 may generate the initialization voltages VINT and VAINT based on the first input voltage VLOUT3. The first regulator 620 may convert the first input voltage VLOUT3 into voltage values set as the initialization voltage VINT and the initialization voltage VAINT and then output the voltage values.

The second regulator 630 may generate a grayscale display voltage VREG based on the third input voltage VLIN. A gamma reference voltage generator 640 may generate a gamma reference voltage VGREF based on the grayscale display voltage VREG. For example, the grayscale display voltage VREG may be used as a top or bottom voltage for generating the gamma reference voltage VGREF.

The third regulator 650 may generate a gate high voltage VGH based on the third input voltage VLIN. The third regulator 650 may output the gate high voltage VGH to the gate driver 300 and the emission driver 500 (e.g., see FIG. 1).

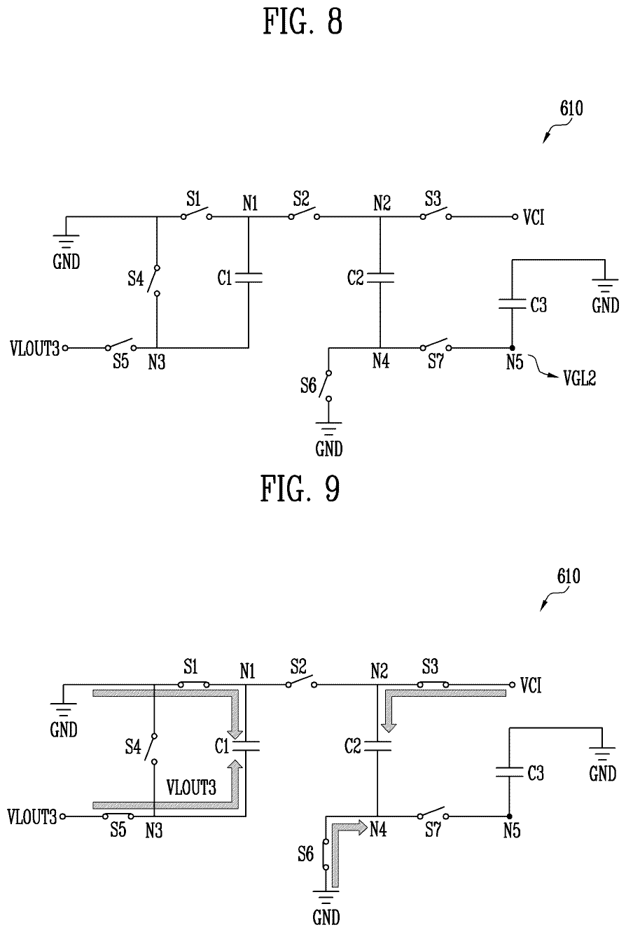

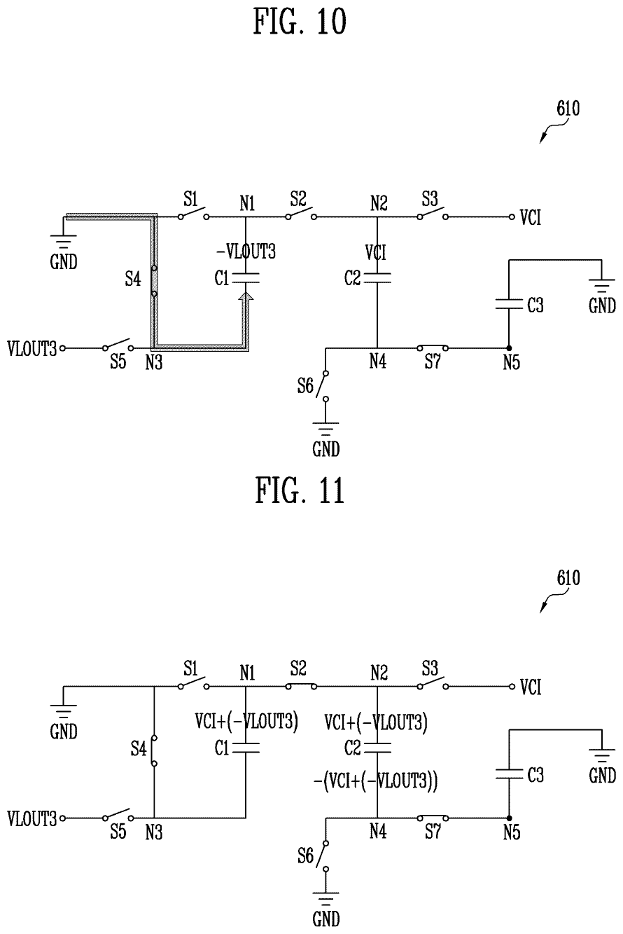

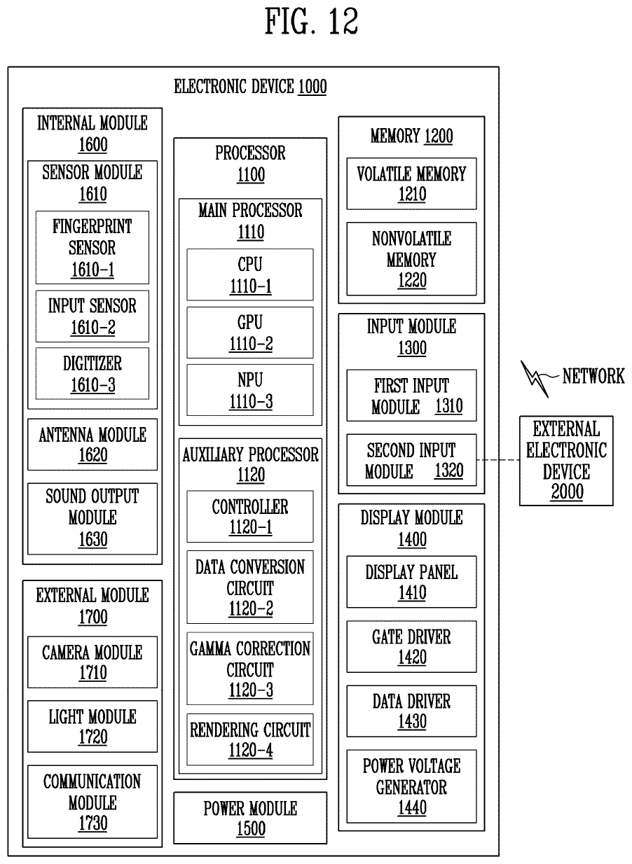

FIG. 8 is a circuit diagram illustrating an example of the second gate low voltage generator 610 shown in FIG. 7. FIG. 9 is a circuit diagram illustrating an example in which the second gate low voltage generator 610 shown in FIG. 8 is driven in a first period of a voltage generation period. FIG. 10 is a circuit diagram illustrating an example in which the second gate low voltage generator 610 shown in FIG. 8 is driven in a second period of the voltage generation period. FIG. 11 is a circuit diagram illustrating an example in which the second gate low voltage generator 610 shown in FIG. 8 is driven in a third period of the voltage generation period.

Referring to FIG. 8, the second gate low voltage generator 610 may output the second gate low voltage VGL2 having a value obtained by subtracting the second input voltage VCI from the first input voltage VLOUT3. For example, the gate low voltage generator 610 may be a charge pump circuit.

For example, the second gate low voltage generator 610 may include a first switch S1 through seventh switch S7. The first switch S1 includes a grounded first terminal (e.g., connected to a reference voltage such as a ground GND) and a second terminal connected to a first node N1. The second switch S2 includes a first terminal connected to the first node N1 and a second terminal connected to a second node N2. The third switch S3 includes a first terminal receiving the second input voltage VCI and a second terminal connected to the second node N2. The fourth switch S4 includes a grounded first terminal and a second terminal connected to a third node N3. The fifth switch S5 includes a first terminal receiving the first input voltage VLOUT3 and a second terminal connected to the third node N3. The sixth switch S6 includes a grounded first terminal and a second terminal connected to a fourth node N4. The seventh switch S7 includes a first terminal connected to the fourth node N4 and a second terminal connected to a fifth node N5.

The second gate low voltage generator 610 may further include a first capacitor C1 to third capacitor C2. The first capacitor C1 includes a first electrode connected to the first node N1 and a second electrode connected to the third node N3. The second capacitor C2 includes a first electrode connected to the second node N2 and a second electrode connected to the fourth node N4. The third capacitor C3 includes a first electrode connected to the fifth node N5 and a grounded second electrode. In addition, the second gate low voltage VGL2 may be generated using a voltage stored in the third capacitor C3.

Referring to FIGS. 8 and 9, in a first period of a voltage generation period in which the second gate low voltage VGL2 is generated, the first switch S1, the third switch S3, the fifth switch S5, and the sixth switch S6 may be turned on. Accordingly, the first electrode of the first capacitor C1 may be grounded, the first input voltage VLOUT3 may be applied to the second electrode of the first capacitor C1, the second input voltage VCI may be applied to the first electrode of the second capacitor C2, and the second electrode of the second capacitor C2 may be grounded. For example, a voltage of the first node N1 may be 0V, a voltage of the third node N3 may be VLOUT3, a voltage of the second node N2 may be VCI, and a voltage of the fourth node N4 may be 0V. VLOUT3 may correspond to a voltage value of the first input voltage VLOUT3, and VCI may correspond to a voltage value of the second input voltage VCI. Hereinafter, this will be equally applied.

Referring to FIGS. 8 and 10, in a second period subsequent to the first period of the voltage generation period, the first switch S1, the third switch S3, the fifth switch S5, and the sixth switch S6 may be turned off, and the fourth switch S4 may be turned on. Accordingly, the second electrode of the first capacitor C1 may be grounded, a voltage of the first electrode of the first capacitor C1 may be changed by a variation in voltage of the second electrode of the first capacitor C1. For example, a voltage of the first node N1 may be −VLOUT3, a voltage of the third node N3 may be 0V, a voltage of the second node N2 may be VCI, and a voltage of the fourth node N4 may be 0V.

Referring to FIGS. 8 and 11, in a third period subsequent to the second period of the voltage generation period, the second switch S2 may be turned on. Accordingly, a voltage of the second electrode of the second capacitor C2 may be changed based on a variation in voltage of the first electrode of the second capacitor C2. In an embodiment, capacitances of the first capacitor C1 and the second capacitor C2 may be the same. For example, a voltage of the first node N1 and the second node N2 may be VCI+(−VLOUT3), a voltage of the third node N3 may be 0V, and a voltage of the fourth node N4 and the fifth node N5 may be −(VCI+(−VLOUT3)) (e.g., VLOUT3−VCI). Therefore, a voltage obtained by subtracting the second input voltage VCI from the first input voltage VLOUT3 (e.g., VLOUT3−VCI) may be stored in the third capacitor C3 and correspond to the second gate low voltage VGL2.

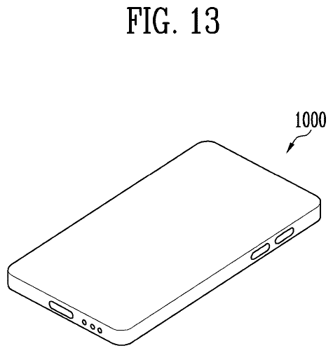

FIG. 12 is a block diagram illustrating an electronic device 1000 in accordance with embodiments of the present disclosure. FIG. 13 is a diagram illustrating an example in which the electronic device 1000 shown in FIG. 12 is implemented as a smartphone.

Referring to FIGS. 12 and 13, the electronic device 1000 may output various types of information through a display module 1400. For example, when a processor 1100 executes an application stored in a memory 1200, the display module 1400 may provide information generated by the application to a user through a display panel 1410. The display panel 1410 may be the display panel shown in FIG. 1.

In an embodiment, as shown in FIG. 13, the electronic device 1000 may be implemented as a smartphone. However, this is merely illustrative, and the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display device, a television, a media player, a gaming system, an appliance control panel, or the like.

The processor 1100 may receive an external input through an input module 1300 or a sensor module 1610, and execute an application corresponding to the external input. In an embodiment, when the user selects a camera icon displayed on the display panel 1410, the processor 1100 may receive a user input through an input sensor 1610-2 and activate a camera module 1710. The processor 1110 may transfer, to the display module 1400, a data signal corresponding to a photographed image acquired through the camera module 1710. The display module 1400 may display an image corresponding to the photographed image through the display panel 1410.

In one embodiment, when personal information authentication is executed in the display module 1400, a fingerprint sensor 1610-1 may acquire input fingerprint information as input data. The processor 1100 may compare the input data received through the fingerprint sensor 1610-1 with authentication data stored in the memory 1200, and execute an application according to a comparison result. The display module 1400 may display information executed according to the logic of the application through the display panel 1410.

In one embodiment, when a music streaming icon displayed on the display module 1400 is selected, the processor 1100 may acquire a user input through the input sensor 1610-2, and activate a music streaming application stored in the memory 1200. When a music play command is input in the music streaming application, the processor 1100 may activate a sound output module 1630, thereby providing the user with sound information which corresponds with the music play command.

In the above, operations of the electronic device 1000 have been briefly described. Hereinafter, components of the electronic device 1000 will be described in detail. Some of the components of the electronic device 1000, which will be described later, may be integrated to be provided as one component. In one embodiment, one component may be separated into two or more components.

The electronic device 1000 may communicate with an external electronic device 2000 through a network (e.g., a short-range wireless communication network (e.g., Bluetooth, WiFi, etc.) or a long-range wireless communication network, for example, a mobile communication network). In accordance with an embodiment, the electronic device 1000 may include the processor 1100, the memory 1200, the input module 1300, the display module 1400, a power module 1500, an internal module 1600, and an external module 1700. In accordance with an embodiment, in the electronic device 1000, at least one of the above-described components may be omitted, or one or more other components may be added. In accordance with an embodiment, some components (e.g., the sensor module 1610, an antenna module 1620, and/or the sound output module 1630) may be integrated in another component (e.g., the display module 1400).

The processor 1100 may control at least one other component (e.g., a hardware or software component) of the electronic device 1000, which is connected to the processor 1100, by executing software and perform various processing or calculations. In accordance with an embodiment, as an example of the data processing and calculations, the processor 1100 may store, in a volatile memory 1210, a command or data received from another component (e.g., the input module 1300, the sensor module 1610, a communication module 1730, etc.). The processor 1100 may process the command or data, stored in the volatile memory 1210, and store result data in a nonvolatile memory 1220.

The processor 1100 may include a processor 1110 and an auxiliary processor 1120. The processor 1110 may include at least one of a central processing unit (CPU) 1110-1 or an application processor (AP). The processor 1110 may further include at least one of a graphic processing unit (GPU) 1110-2, a communication processor (CP), or an image signal processor (ISP). The processor 1110 may further include a neural processing unit (NPU) 1110-3. The NPU 1110-3 is a processor specified for processing an artificial intelligence (AI) model, and the AI model may be generated through machine learning.

The AI model may include a plurality of artificial neural network layers. An artificial neural network may be a deep neural network (DNN), a convolutional neural network (CNN), a recurrent neural network (RNN), a restricted boltzman machine (RBM), a deep belief network (DBN), a bidirectional recurrent deep neural network (BRDNN), a deep Q-networks, or one of two or more combinations thereof, but the present disclosure is not limited to the above-described example. The AI model may additionally or alternatively include a software structure, in addition to a hardware structure. At least two of the above-described processing units and the above-described processors may be implemented into one integrated component (e.g., a single chip), or be implemented as components (e.g., a plurality of chips) independent from each other.

The auxiliary processor 1120 may include a controller 1120-1. The controller 1120-1 may include, for example, an interface conversion circuit and a timing control circuit. The controller 1120-1 may receive input image data from the processor 1110, and convert a data format of the input image data to be suitable for interface specifications with the display module 1400, thereby outputting a data signal. The controller 1120-1 may output various control signals for driving of the display module 1400.

In one embodiment, the auxiliary processor 1120 may include a data conversion circuit 1120-2, a gamma correction circuit 1120-3, a rendering circuit 1120-4, and the like. The data conversion circuit 1112-2 may receive a data signal from the controller 1120-1, and compensate for the data signal to display an image with a desired luminance according to a characteristic of the electronic device 1000 or a setting of the user, or may convert the data signal for the purpose of reducing power consumption, afterimage compensation, or the like.

The gamma correction circuit 1120-3 may convert a data signal, a gamma reference voltage, or the like to perform a gamma correction scheme, such that an image displayed in the electronic device 1000 has a desired gamma characteristic.

The rendering circuit 1120-4 may receive a data signal from the controller 1120-1 and render the data signal by considering a pixel arrangement of the display panel 1410, and the like, applied to the electronic device 1000. At least one of the data conversion circuit 1120-2, the gamma correction circuit 1120-3, or the rendering circuit 1120-4 may be integrated in another component (e.g., the processor 1110 or the controller 1120-1).

At least one of the controller 1120-1, the data conversion circuit 1120-2, the gamma correction circuit 1120-3, and the rendering circuit 1120-4 may be integrated in a data driver 1430 which will be described later. In one embodiment, the auxiliary processor 1120 may be the driving controller shown in FIG. 1.

The memory 1200 may store various kinds of data used by at least one component (e.g., the processor 1100 or the sensor module 1610) of the electronic device 1000, and may input or output data about a command associated therewith. The memory 1200 may include at least one of the volatile memory 12101 or the nonvolatile memory 1220.

The input module 1300 may receive a command or data to be used in a component (e.g., the processor 1100, the sensor module 1610, or the sound output module 1630) of the electronic device 1000 from a host or external source (e.g., initiated from a user or the external electronic device 2000) of the electronic device 1000.

The input module 1300 may include a first input module 1310 to which a command or data is input from the user and a second input module 1320 to which a command or data is input from the external electronic device 2000. The first input module 1310 may include a microphone, a mouse, a keyboard, a key (e.g., a button), or a pen (e.g., a passive pen or an active pen). The second input module 1320 may support a specified protocol capable of connecting the electronic device 1000 to the external electronic device 2000 by wired or wireless communications. In accordance with an embodiment, the second input module 1320 may include a high definition multimedia interface (HDMI), a universal serial bus (USB) interface, an SD card interface, and/or an audio interface. The second input module 1320 may include a connector, e.g., an HDMI connector, a USB connector, an SD card connector, and/or an audio connector (e.g., a headphone connector), which can physically connect the electronic device 1000 to the external electronic device 2000.

The display module 1400 may visually provide information to the user. The display module 1400 may include the display panel 1410, a gate driver 1420, and the data driver 1430. The display module 1400 may further include a window for protecting the display panel 1410, a chassis, and a bracket. The gate driver 1420 and the data driver 1430 may be the gate driver and the data driver, which are shown in FIG. 1.

The display panel 1410 may be one of a variety of display panels. For example, the display panel 1410 may be a liquid crystal display panel, an organic light emitting display panel, or an inorganic light emitting display panel. The kind of the display panel 1410 is not particularly limited. The display panel 1410 may be of a rigid type or a flexible type, in which the display panel 1410 is rollable, bendable, or foldable. The display module 1400 may further include a supporter for supporting the display panel 1410, a bracket, a heat dissipation member, or the like.

The gate driver 1420 may be a driving chip and may be mounted in the display panel 1410. Also, the gate driver 1420 may be integrated in the display panel 1410. For example, the gate driver 1420 may include an Amorphous Silicon TFT Gate (ASG) driver circuit, a Low Temperature Polycrystalline Silicon (LTPS) TFT gate driver circuit, or an Oxide Semiconductor TFT Gate (OSG) driver circuit, which is embedded in the display panel 1410. The gate driver 1420 may receive a control signal from the controller 1120-1, and output gate signals to the display panel 1410 in response to the control signal.

The display module 1400 may further include an emission driver. The emission driver may output an emission control signal to the display panel 1410 in response to a control signal received from the controller 1120-1. The emission driver may be formed separately from the gate driver 1420, or may be integrated in the gate driver 1420. The emission driver may be the emission driver shown in FIG. 1.

The data driver 1430 may receive a control signal from the controller 1120-1, convert a data signal into an analog voltage (e.g., one or more data voltages), and then output data voltages to the display panel 1410 in response to the control signal. The data driver 1430 may be the data driver 400 in FIG. 1.

The data driver 1430 may be integrated in another component (e.g., the controller 1120-1). Functions of the interface conversion circuit and the timing control circuit of the controller 1120-1, which are described above, may be integrated in the data driver 1430.

The display module 1400 may further include a power voltage generator 1440. The power voltage generator 1440 may output various voltages for driving of the display panel 1410. The power voltage generator 1440 may be the power voltage generator 600 shown in FIG. 1. As described above, two or more components among the auxiliary processor 1120, the data driver 1430, and the power voltage generator 1440 may be mounted in one integrated circuit.

The power module 1500 (e.g., a voltage supply) may supply power to at least one component of the electronic device 1000. The power module 1500 may include a battery for charging a power voltage. The battery may include a primary cell which is not rechargeable, a secondary cell which is rechargeable, or a fuel cell. In one embodiment, the power module 1150 may include a power management integrated circuit (PMIC). The PMIC may supply an optimized or suitable power source to each of the above-described modules and modules which will be described later. For example, the PMIC may supply first to third input voltages to the power voltage generator 1440, and supply the first input voltage as a first gate low voltage to the gate driver 1420 and the emission driver (e.g., emission driver 500). The power module 1500 may include a wireless power transmission/reception circuit electrically connected to the battery. The wireless power transmission/reception circuit may include a plurality of coil-shaped antenna radiators.

The electronic device 1000 may further include the internal module 1600 and the external module 1700. The internal module 1600 may include the sensor module 1610, the antenna module 1620, and the sound output module 1630. The external module 1700 may include the camera module 1710, a light module 1720, and the communication module 1730.

The sensor module 1610 may sense an input made by a part of the body (e.g., finger) of the user or an input caused by a pen in the first input module. The sensor module 1610 may generate an electrical signal or a data value which corresponds to the input. The sensor module 1610 may include at least one of the fingerprint sensor 1610-1, the input sensor 1610-2, or a digitizer 1610-3.

The fingerprint sensor 1610-1 may generate a data value corresponding to a fingerprint of the user. The fingerprint sensor 1610-1 may include any one of an optical-type fingerprint sensor or a capacitive-type fingerprint sensor.

The input sensor 1610-2 may generate a data value corresponding to coordinate information of the input made the body part of the user or an input caused by the pen. The input sensor 1610-2 may generate, as a data value, a capacitance variation caused by the input. The input sensor 1610-2 may sense an input made by a passive pen, or may transmit/receive data to/from an active pen.

The input sensor 1610-2 may measure a biometric signal such as, but not limited to, pressure, moisture or body fat. For example, when the user does not move over a constant period of time while a body part of the user is in contact with a sensor layer or a sensing panel, the input sensor 1610-2 may output information which the user wants to the display module 1400 by sensing a biometric signal, based on a change in electric field, caused by the body part.

The digitizer 1610-3 may generate a data value corresponding to the coordinate information of the input made by the pen. The digitizer 1610-3 may generate, as a data value, an electromagnetic variation caused by the input. The digitizer 1610-3 may sense an input made by the passive pen, or transmit/receive data to/from the active pen.

At least one of the fingerprint sensor 1610-1, the input sensor 1610-2, or the digitizer 1610-3 may be implemented as a sensor layer formed on the display panel 1410, for example, through a continuous process. At least one of the fingerprint sensor 1610-1, the input sensor 1610-2, or the digitizer 1610-3 may be disposed at a predetermined (e.g., an upper) side of the display panel 1410, and any one, e.g., the digitizer 1610-3 among the fingerprint sensor 1610-1, the input sensor 1610-2, and the digitizer 1610-3 may be disposed at another (e.g., lower) side of the display panel 1410.

At least two of the fingerprint sensor 1610-1, the input sensor 1610-2, or the digitizer 1610-3 may be formed to be integrated into one sensing panel through the same process. When at least two of the fingerprint sensor 1610-1, the input sensor 1610-2, or the digitizer 1610-3 are integrated into one sensing panel, the sensing panel may be disposed between the display panel 1410 and the window disposed at one side (e.g., an upper side) of the display panel 1410. In accordance with an embodiment, the sensing panel may be disposed on the window, and the position of the sensing panel may be at another location in another embodiment.

At least one of fingerprint sensor 1610-1, the input sensor 1610-2, or the digitizer 1610-3 may be built into or integrated within the display panel 1410. For example, at least one of fingerprint sensor 1610-1, the input sensor 1610-2, or the digitizer 1610-3 may be simultaneously formed through a process of forming elements (e.g., a light emitting element, a transistor, and the like) included in the display panel 1410.

The sensor module 1610 may generate an electrical signal or a data value, which corresponds to an internal state or an external state of the electronic device 1000. The sensor module 1610 may further include one or more sensors. For example, the sensor module 1610 may include a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The antenna module 1620 may include one or more antennas for transmitting a signal or power to an external device or receiving a signal or power from an external device or source. In accordance with an embodiment, the communication module 1730 may transmit a signal to the external electronic device or receive a signal from the external electronic device through an antenna suitable for any one of a variety of communication protocols. An antenna pattern of the antenna module 1620 may be integrated in one component (e.g., the display panel 1410) of the display module 1400, the input sensor 1610-2, or the like.

The sound output module 1630 outputs a sound signal outside of the electronic device 1000, and may include, for example, a speaker used for a general purpose such as multimedia playback or transcription playback, and a receiver used for call reception. In accordance with an embodiment, the receiver may be integrally formed with the speaker or be formed separately from the speaker. A sound output pattern of the sound output module 1630 may be integrated in the display module 1400.

The camera module 1710 may photograph a still image or a moving image. In accordance with an embodiment, the camera module 1710 may include a flash, one or more lenses, an image sensor, or an image signal processor. The camera module 1710 may further include an infrared camera capable of sensing the presence of the user, a position of the user, eyes of the user, or the like.

The light module 1720 may provide light. For example, the light module 1720 may include a light source, which, for example, may be a light emitting diode or a xenon lamp. The light module 1720 may operate in tandem with the camera module 1710 or may operate independently from the camera module 1710.

The communication module 1730 may establish a wired or wireless communication channel between the electronic device 1000 and the external electronic device 2000, and support communication performance through the established communication channel. The communication module may include any one or all of a wireless communication module or a wired communications module. Examples of the wireless communication module include a cellular communication module, a short-range wireless communication module, or a global navigation satellite system (GNSS) communication module. Examples of a wired communication module include a local area network (LAN) communication module or a power line communication (PLC) module. The communication module 1730 may communicate with the external electronic device 2000 through a short-range communication network (such as Bluetooth™, wireless-fidelity (WiFi) direct, or infrared data association (IrDA)) or a long-range communication network such as a cellular network, Internet, or a computer network (e.g., LAN or wide area network (WAN)). The above-described several kinds of communication modules may be implemented into one chip or may be implemented as separate chips.

The input module 1300, the sensor module 1610, the camera module 1710, and the like may be used to control operation of the display module 1400 in tandem with the processor 1100.

The processor 1100 may output commands and/or data to the display module 1400, the sound output module 1630, the camera module 1710, or the light module 1720, based on input data received from the input module 1300. For example, the processor 1100 may generate a data signal corresponding to input data applied, for example, through a mouse, an active pen, or the like. The processor 1100 may output the data signal to the display module 1400. In one embodiment, the processor 1100 may generate command data corresponding to the input data, and may output the command data to the camera module 1710 or the light module 1720. When no input data is received from the input module 1300 for a certain time, the processor 1100 may change the operation mode of the electronic device 1000 to a low power mode or a sleep mode, thereby reducing power consumption in the electronic device 1000.

The processor 1100 may output a command or data to the display module 1400, the sound output module 1630, the camera module 1710, or the light module 1720, based on sensing data received from the sensor module 1610. For example, the processor 1100 may compare authentication data applied by the fingerprint sensor 1610-1 with authentication data stored in the memory 1200, and then execute an application or security feature according to a comparison result. The processor 1100 may execute a command or output a corresponding data signal to the display module 1400 based on sensing data sensed by the input sensor 1610-2 or the digitizer 1610-3. When a temperature sensor is included in the sensor module 1610, the processor 1100 may receive temperature data indicative of a temperature measured from the sensor module 1610, and may perform luminance correction on a data signal based on the temperature data.

The processor 1100 may receive measurement data corresponding to the presence of a user, a position of the user, eyes of the user, or the like from the camera module 1710. The processor 1100 may perform luminance correction on a data signal based on the measurement data. For example, the processor 1100 may determine the presence of a user through an input from the camera module 1710, and may output a data signal having a luminance that is corrected to the display module 1400 through the data conversion circuit 1120-2 or the gamma correction circuit 1120-3.

At least some of the above-described components may be connected to each other and communicate signals (e.g., commands or data) therebetween through an inter-peripheral communication scheme. Examples of the inter-peripheral communication scheme include, but are not limited to, a bus, a general purpose input/output (GPIO), a serial peripheral interface (SPI), a mobile industry processor interface (MIPI), or an ultra path interconnect (UPI) link. The processor 1110 may communicate with the display module 1140 through an appointed interface, and may use any one of the above-described communication schemes or protocols. However, the present disclosure is not limited to the above-described communication schemes.

The present disclosure can be applied to display devices and electronic devices including the same. For example, the present disclosure can be applied to digital TVs, 3D TVs, computer monitors, mobile phones, smart phones, tablet computers, VR devices, PCs, home appliances, notebook computers, PDAs, PMPs, digital cameras, music players, portable game consoles, navigation systems, and the like.

In accordance with the present disclosure, the display device generates a second gate low voltage by which a relatively small current is generated through the power voltage generator, and may supply, as an input voltage, a first gate low voltage by which a relatively large current is generated to the gate driver, so that the power consumption of the power voltage generator can be reduced.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, devices, modules, drivers, units, generators, regulators, interfaces, and other signal generating and signal processing features of the embodiments disclosed herein may be implemented, for example, in non-transitory logic that may include hardware, software, or both. When implemented at least partially in hardware, the controllers, processors, devices, modules, drivers, units, generators, regulators, interfaces, and other signal generating and signal processing features may be, for example, any one of a variety of integrated circuits including but not limited to an application-specific integrated circuit, a field-programmable gate array, a combination of logic gates, a system-on-chip, a microprocessor, or another type of processing or control circuit. In some embodiments, these features may be implemented by a neural network, machine-learning logic, or other form of artificial intelligence.

When implemented in at least partially in software, the controllers, processors, devices, modules, drivers, units, generators, regulators, interfaces, and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims. The embodiments may be combined to form additional embodiments.

What is claimed is:

1. A display device comprising:
a display panel including sub-pixels;
a gate driver; and
a driver integrated circuit includes a data driver configured to provide data voltages to the sub-pixels, and a power voltage generator configured to receive a first input voltage and a second input voltage, generate a second gate low voltage based on the first input voltage and the second input voltage, and provide the second gate low voltage to the gate driver, wherein the gate driver is configured to receive the first input voltage as a first gate low voltage and provide gate signals to the sub-pixels.

2. The display device of claim 1, wherein the second gate low voltage has a value obtained by subtracting the second input voltage from the first input voltage.

3. The display device of claim 1, wherein the power voltage generator includes a charge pump circuit configured to generate the second gate low voltage based on the first input voltage and the second input voltage.

4. The display device of claim 3, wherein the charge pump circuit includes:
a first switch including a first terminal coupled to a first reference potential and a second terminal connected to a first node;
a second switch including a first terminal connected to the first node and a second terminal connected to a second node;
a third switch including a first terminal receiving the second input voltage and a second terminal connected to the second node;
a fourth switch including a first terminal coupled to a second reference potential and a second terminal connected to a third node;
a fifth switch including a first terminal configured to receive the first input voltage and a second terminal connected to the third node;
a sixth switch including a first terminal coupled to a third reference potential and a second terminal connected to a fourth node;
a seventh switch including a first terminal connected to the fourth node and a second terminal connected to a fifth node;
a first capacitor including a first electrode connected to the first node and a second electrode connected to the third node;
a second capacitor including a first electrode connected to the second node and a second electrode connected to the fourth node; and
a third capacitor including a first electrode connected to the fifth node and a second electrode connected to a fourth reference potential, wherein the second gate low voltage is generated using a voltage stored in the third capacitor.

5. The display device of claim 4, wherein:
a voltage generation period in which the second gate low voltage is generated includes a first period, a second period subsequent to the first period, and a third period subsequent to the second period, and
the first switch, the third switch, the fifth switch, and the sixth switch are configured to be turned on in the first period,
the fourth switch is configured to be turned on in the second period, and
the second switch and the seventh switch are configured to be turned on in the third period.

6. The display device of claim 1, wherein the gate driver is configured to output the first gate low voltage as a low logic level of the gate signals.

7. The display device of claim 6, wherein:
the gate driver includes a stage configured to output at least one of the gate signals,
the stage includes:
an input stage transistor including a control electrode configured to receive a first clock signal, a first electrode configured to receive an input signal, and a second electrode connected to a first stage node;
a controller configured to control a signal of a second stage node and a signal of a third stage node based on a signal of the first stage node;
a first output stage transistor including a control electrode connected to the second stage node, a first electrode configured to receive a gate high voltage, and a second electrode connected to an output terminal; and
a second output stage transistor including a control electrode connected to the third stage node, a first electrode configured to receive the first gate low voltage, and a second electrode connected to the output terminal, wherein the stage is configured to output the gate high voltage or the first gate low voltage.

8. The display device of claim 1, wherein the second input voltage is applied to at least one of a back gate electrode of a transistor included in the controller or a back gate electrode of the input stage transistor.

9. The display device of claim 1, wherein an absolute value of the second gate low voltage is greater than an absolute value of the first gate low voltage.

10. The display device of claim 1, wherein each of the first gate low voltage and the second gate low voltage has a negative value.

11. The display device of claim 1, wherein the second input voltage is greater than the first input voltage.

12. The display device of claim 1, wherein:
the first input voltage has a negative value, and
the second input voltage has a positive value.

13. The display device of claim 1, wherein the second input voltage is greater than the second gate low voltage.

14. The display device of claim 1, further comprising:
an emission driver configured to receive the first input voltage as the first gate low voltage, receive the second gate low voltage from the power voltage generator, and provide emission signals to the sub-pixels.

15. The display device of claim 14, wherein the emission driver is configured to output the first gate low voltage as a low logic level of the emission signals.

16. The display device of claim 15, wherein:
the emission driver includes a stage configured to output at least one of the emission signals, and
the stage includes:
an input stage transistor including a control electrode configured to receive a first clock signal, a first electrode configured to receive an input signal, and a second electrode connected to a first stage node;
a controller configured to control a signal of a second stage node and a signal of a third stage node based on a signal of the first stage node;
a first output stage transistor including a control electrode connected to the second stage node, a first electrode configured to receive a gate high voltage, and a second electrode connected to an output terminal; and
a second output stage transistor including a control electrode connected to the third stage node, a first electrode configured to receive the first gate low voltage, and a second electrode connected to the output terminal, wherein the stage is configured to output the gate high voltage or the first gate low voltage.

17. The display device of claim 14, wherein the second input voltage is applied to at least one of a back gate electrode of a transistor included in the controller or a back gate electrode of the input stage transistor.

18. The display device of claim 1, wherein:
at least one of the sub-pixels is configured to receive an initialization voltage, and
the power voltage generator is configured to generate the initialization voltage based on the first input voltage.

19. The display device of claim 18, wherein the power voltage generator includes a regulator configured to receive the first input voltage to generate the initialization voltage.

20. An electronic device comprising:
a display device;
a processor configured to provide input image data to the display device, the display device configured to receive the input image data to display an image; and
a voltage supply configured to provide a first input voltage and a second input voltage to the display device, wherein the display device includes:
a display panel including sub-pixels;
a gate driver; and
a driver integrated circuit including a data driver configured to provide data voltages to the sub-pixels, and a power voltage generator configured to receive the first input voltage and the second input voltage, generate a second gate low voltage based on the first input voltage and the second input voltage, and provide the second gate low voltage to the gate driver; wherein the gate driver is configured to receive the first input voltage as a first gate low voltage and provide gate signals to the sub-pixels.

21. A power voltage generator, comprising:
a regulator configured to generate a first voltage based on a first signal; and
a voltage generator configured a second voltage based on a first input voltage and a second input voltage, wherein:
each of the regulator and the voltage generator is electrically connected to a driver of a display device,
the first voltage corresponds to a logical high voltage for the driver and the first input voltage corresponds to a logical low voltage for the driver, and
the second voltage is a back gate bias voltage for at least one transistor in the driver.

22. The power voltage generator of claim 21, wherein the first signal is a third input voltage.

23. The power voltage generator of claim 21, wherein the second input voltage is greater than the first input voltage.

24. The power voltage generator of claim 21, wherein the second input voltage is greater than the second voltage.

25. The power voltage generator of claim 21, wherein the second voltage is equal to the first input voltage minus the second input voltage.
